(19) United States
(12) Patent Application Publication
(10) Pub. No.: US 2023/0422361 A1
(43) Pub. Date: Dec. 28, 2023

(54) OPERATING A HOUSEHOLD MICROWAVE APPLIANCE

(71) Applicant: BSH Hausgeräte GmbH, (US)

(72) Inventors: Markus Kuchler, Gstadt am Chiemsee (DE); Kerstin Rigorth, Mühldorf (DE); Sebastian Sterz, Großaitingen (DE); Matthias Vogt, Gundelfingen Donau (DE)

(21) Appl. No.: 18/038,235

(22) PCT Filed: Nov. 16, 2021
(86) PCT No.: PCT/EP2021/081826

§ 371 Date: May 23, 2023

(30) Foreign Application Priority Data
Dec. 10, 2020 (DE) 102020215681.6

(51) Int. Cl. H05B 6/64; H05B 6/74; H05B 6/68

(52) U.S. Cl. CPC H05B 6/6455; H05B 6/745; H05B 6/687; H05B 6/6411

(57) ABSTRACT

A household microwave appliance operates with multiple parameter configurations to treat food to be cooked in a locally differing manner. The microwave appliance determines in an initial scan with a thermal imaging sensor directed into the cooking chamber a temperature distributions on a surface of the food to be cooked. Change patterns are obtained from differences between different temperature distributions. An evaluation value is calculated for a best heating pattern that brings the current temperature distribution closest to a target temperature distribution determined based on a normalized target state and a current temperature distribution, whereafter microwave power is applied to the food to be cooked with the parameter configuration associated with the best heating pattern.

The invention relates to a method for operating a household microwave appliance having a cooking compartment, which can be loaded with food to be cooked, a microwave generator for generating microwaves, by means of which it is possible to influence the food to be cooked that is located in the cooking compartment, at least one thermal imaging sensor, which is oriented into the cooking compartment, for determining temperature distributions <T> on a surface of the food to be cooked and a control apparatus that is configured so as to set multiple parameter configurations Sₚ, S_{q} of setting parameters of the household microwave appliance, wherein due to at least two parameter configurations Sₚ, S_{q} the food to be cooked can be treated differently in a localized manner using microwaves, wherein in the case of the method, microwaves can be supplied into the cooking compartment under different parameter configurations Sₚ, S_{q}, temperature distributions <T>ₚ, <T>_{q} on the surface of the food to be cooked, which are associated with the parameter configurations Sₚ, S_{q}, are measured by means of the at least one thermal imaging sensor and heating patterns <ΔT>_{p,q} are determined from differences of different temperature distributions <T>ₚ, <T>_{q}. The invention also relates to a corresponding household microwave appliance.

US 2018/0098381 A1 and US 2017/0290095 A1 disclose a computer implemented method for heating an object in a cooking compartment of an electronic oven to a target state. The method comprises heating the object using a set of applications of energy in relation to the cooking compartment while the oven is in a specific configuration. The set of applications of energy and the configuration define a respective set of variable energy distributions in the compartment. The method also comprises collecting sensor data that defines a respective set of responses of the food to be cooked to the set of applications of energy. The method also comprises generating a plan for heating the object in the compartment. The plan is produced by a control system of the oven and the plan uses the sensor data.

WO 2012/109634 A1 discloses an apparatus for treating objects with HF energy. The apparatus can include a display in order to display to a user an image of an object that is to be processed, wherein the image comprises at least a first part and a second part of the object. The apparatus can also comprise an input unit and at least one processor that is configured so as to: receive information based on an input that is provided to the input unit, and so as to generate processing information for use as the object is being processed based on the information that is received in order to achieve a first processing result in the first section of the object and a second processing result in the second section of the object.

DE 10 2017 101 183 A1 relates to a method for operating a cooking appliance and also a cooking appliance in which food to be cooked is heated in a cooking compartment using a heating facility. The food to be cooked is captured using a camera facility. At least one parameter of the food to be cooked is ascertained with the aid of the capture of the food to be cooked. In this case, the heating facility comprises a heat source having a plurality of separately controllable heating means. A spatial segment of a plurality of spatial segments in the cooking compartment is specifically heated using in each case at least one heating means. The control of the individual heating means is performed in dependence upon the parameter of the food to be cooked.

DE 10 2019 101 695 A1 discloses a method for cooking food to be cooked in a cooking appliance having a cooking compartment, having at least one high frequency facility for introducing high frequency radiation, in particular microwave radiation, into the cooking compartment, having at least one control facility for controlling the high frequency facility so that at least one field distribution of the high frequency radiation can be influenced, and having at least one camera facility that is suitable and designed so as to capture and to provide to the control facility at least one thermal image of the cooking compartment, characterized by the following method steps: introducing by means of the high frequency facility high frequency radiation having a first field distribution into the cooking compartment, which has the food to be cooked located therein; capturing at least one thermal image of the cooking compartment and of the food to be cooked, which is located therein, during the introduction of the high frequency radiation having the first field distribution and providing the thermal image to the control facility; calculating by the control facility from the at least one thermal image a measurement for a heat distribution in at least one region on the food to be cooked; changing the field distribution of the high frequency radiation by the control facility if the measurement for the heat distribution deviates by a predetermined value from a predetermined measurement.

DE 10 2018 219 086 A1 discloses a method for operating a household microwave appliance and a corresponding household microwave appliance. The household microwave appliance has a cooking compartment, at least one facility for treating the food to be cooked for treating food to be cooked, which is located in the cooking compartment, having multiple parameter configurations, wherein the food to be cooked can be treated differently in a localized manner due to at least two parameter configurations, and at least one sensor, which is oriented into the cooking compartment, for determining measured value distributions <V> of a surface characteristic of the food to be cooked, wherein in the case of the method the at least one facility for treating the food to be cooked is operated for a predetermined period of time using one of the parameter configurations in order to treat food to be cooked that is located in the cooking compartment, following the expiration of the period of time by means of the at least one sensor a measured value distribution <V> of a surface characteristic of the food to be cooked is determined, a quality value is determined from the measured value distribution <V> and in the event of the quality value not meeting a predetermined quality criterion, the facility for treating the food to be cooked is subsequently operated using another of the parameter configurations, wherein the quality value is determined from a comparison of at least two different scalar values that are calculated from the same at least one measured value distribution <V>.

The above methods of the prior art have the disadvantage that for their implementation they require a tracking of the temperature distribution of the food to be cooked. This is then disadvantageous if an introduction of microwave energy into the food to be cooked does not lead or does not predominantly lead to a temperature increase and/or if the temperature distribution of the food to be cooked cannot be measured or can only be measured particularly imprecisely. Moreover, at least the methods that are described in US 2018 0098381 A1, US 2017/0290095 A1 and WO 2012/109634 A1 are comparably complex in their implementation.

The object of the present invention is to at least in part overcome the disadvantages of the prior art and in particular to provide a particularly easily implementable and effective possibility for treating food to be cooked automatically to a desired surface characteristic even if the temperature distribution that is measured in this case does not represent an expedient measurement for an energy absorption by the food to be cooked.

This object is achieved in accordance with the features of the independent claims. Preferred embodiments are apparent in particular in the dependent claims.

The object is achieved by a method for operating a household microwave appliance, wherein the household microwave appliance has a cooking compartment that can be loaded with food to be cooked, a microwave generator for generating microwaves by means of which it is possible to influence the food to be cooked that is located in the cooking compartment, at least one thermal imaging sensor, which is oriented into the cooking compartment, for determining temperature distributions <T> on a surface of the food to be cooked and a control apparatus that is configured so as to set multiple parameter configurations Sₚ, S_{q} of setting parameters of the household microwave appliance, wherein due to at least two parameter configurations Sₚ, S_{q} the food to be cooked can be treated differently in a localized manner using microwaves, wherein in the case of the method, after loading the cooking compartment with the food to be cooked, a specific procedure (referred to below without limiting the generality as “initial scan”) is performed, in which
microwaves are supplied into the cooking compartment under different parameter configurations Sₚ, S_{q},
temperature distributions <T>ₚ, <T>_{q} on the surface of the food to be cooked, which are associated with the parameter configurations Sₚ, S_{q}, are measured by means of the at least one thermal imaging sensor and
heating patterns <ΔT>_{p,q} are determined from differences of different temperature distributions <T>ₚ, <T>_{q},
and following the initial scan
   (a) based on a standardized target distribution <Z> and a prevailing temperature distribution <T> at least one target temperature distribution <T_{target}>, <T_{target}*> is set for the food to be cooked,
   (b) based on the prevailing temperature distribution <T> a heating pattern <ΔT>_{p,q|best} that is most suitable for achieving the at least one target temperature distribution <T_{target}>, <T_{target}*> is determined and
   (c) the food to be cooked is influenced using microwaves under the sequence of parameter configurations Sₚ, S_{q} that is associated with the most suitable heating pattern <ΔT> and
   (d) the previously prevailing temperature distribution <T> plus the heating pattern <ΔT>_{p,q|best} that is associated with the most suitable heating pattern <ΔT>_{p,q|best} is determined as a new prevailing temperature distribution <T>.

In the case of this method, the initial scan is typically performed immediately or shortly after introducing the food to be cooked into the cooking compartment, wherein the food to be cooked has still not reached a “saturation state” as is described more precisely below. Due to the use of the initial scan, the advantage is achieved that heating patterns <ΔT> are determined “in advance” during a warming up phase of the food to be cooked with the result that these heating patterns <ΔT> can be used in the saturation state of the food to be cooked, which chronologically follows the warming up phase, so as to control a microwave influence in a locally specific manner. In particular, food to be cooked can consequently also then be heated uniformly or in a specific non-uniform manner if after the initial scan a capture of thermal images of the surface of the food to be cooked no longer provides expedient results that can be used for the control of the microwave supply, for example while defrosting or cooking food to be cooked.

In this case, it is taken into consideration that during the warming up phase the quantity of microwave energy that is supplied into the cooking compartment is a good approximation to linear with respect to a temperature increase on the surface of the food to be cooked, in other words the temperature increase is an expedient measure for the quantity of energy that is absorbed by the food to be cooked. Conversely, if the food to be cooked is in its saturation state, the quantity of microwave energy that is absorbed is used at least to a noticeable extent for other mechanisms than a temperature increase, for example for a phase transformation of water that is stored in the food to be cooked. As a consequence, during the saturation state an introduction of microwave energy into the food to be cooked does not lead or does not predominantly lead to a temperature increase.

The period of time during a microwave treatment procedure in which the food to be cooked is in its saturation state can also be referred to as “saturation phase”. In the saturation phase, the food to be cooked can consequently also then be specifically influenced with microwaves so as to achieve the desired target temperature distribution <T_{target}> on the surface of the food to be cooked if a change in the temperature distribution <T> no longer represents an expedient measure for the microwave power that is absorbed. In particular, it is possible by means of the method in other words advantageously to also then achieve a target temperature distribution <T_{target}> of the food to be cooked with good accuracy if the temperature distribution is no longer measured during the saturation phase or used so as to control the microwave influence.

A further advantage resides in the fact that the method can be performed in a purely iterative manner or step for step and consequently a complex creation of plans for setting multiple consecutive parameter configurations, for example on the basis of artificial intelligence, can be omitted, which considerably reduces a computing outlay.

A yet further advantage is that a high tolerance with respect to process interruptions and adaptations of the starting conditions is provided even during the warming up phase. If a user interrupts for example a warming up phase in order to add or remove more food to be cooked, then the method can be restarted without more precise disclosure of the changes that are made since then due to a repeated initial scan the basic conditions (for example a non-uniform starting temperature, a changed quantity or shape) can be captured. The method that is proposed here is in other words particularly customer friendly and tolerant to change and/or error.

The warming up phase can correspond for example to the procedure for heating frozen food to be cooked until reaching the saturation state of the food to be cooked (in other words its part defrosted state in which in at least one spatial region of the food to be cooked the quantity of microwave energy that is absorbed is used for the phase transformation from solid to liquid). While such a phase transition does not increase the temperature despite the absorption of microwave energy, since the majority of the microwave energy introduction must be applied for the application of enthalpy of fusion, but rather usually remains in a region of 0° C. A thermal imaging sensor can consequently not determine in a spatially resolved manner how far the defrosting procedure has already progressed and accordingly it is not possible to control the defrosting process with the aid of the data that is collected by the thermal imaging sensor. An associated saturation phase corresponds to a period of time of the microwave treatment procedure in which a noticeable defrosting of water already takes place in at least one spatial region of the food to be cooked.

The warming up phase can also correspond to the procedure for heating unfrozen food to be cooked until reaching a state of the food to be cooked (in other words a part-cooked state in which in at least one spatial region of the food to be cooked the quantity of microwave energy that is absorbed is used for the phase transformation from liquid to gaseous). During such a phase transition, despite the absorption of microwave energy the temperature does not increase at least until a thoroughly cooked (waterless) state is reached on the surface. An associated saturation phase consequently corresponds to a period of time of the microwave treatment procedure in which in at least one spatial region of the food to be cooked a noticeable evaporation or boiling of water takes place.

The two examples above of warming up phase and saturation phase are described more precisely below. In both cases, the heating patterns that are ascertained prior to reaching the saturation state can be used so as to also specifically influence the food to be cooked using microwaves during the defrosting/evaporation to a desired target distribution without further temperature measurement.

In one development, the household microwave appliance is a standalone microwave appliance or a microwave combination appliance, for example an oven and/or a steam treatment appliance having an additional microwave functionality, a microwave oven having additional heat radiators (for example resistance heating bodies), etc. In the closed state, the cooking compartment is sealed with respect to microwaves.

The microwave generator can be a magnetron or a semiconductor-based microwave generator. The microwaves that are generated by the microwave generator are supplied into the cooking compartment for example directly or via a microwave guiding arrangement. If the microwave generator is a semiconductor-based microwave generator, in one development this can be a variable frequency microwave generator, in other words can generate microwaves having different frequencies.

The thermal imaging sensor can be any IR or thermal sensor that generates a spatially resolved thermal image, for example a thermal image camera, a group of thermopiles etc. Due to the fact that the thermal imaging sensor is oriented into the cooking compartment, a temperature distribution <T> of objects that are located in the viewing field of the thermal imaging sensor, for example of food to be cooked, can be measured or sensed. The food to be cooked can be differentiated in the thermal image by means of known methods for image processing, for example by object recognition, from an environment of the food to be cooked such as a carrier for food to be cooked. For this purpose, it is possible to use for example the thermal imaging sensor and/or a camera that is sensitive to the visible wavelength range.

An “i-th” parameter configuration Sᵢ can be understood to mean a specific set of values of at least one setting parameter of the household microwave appliance, wherein it is possible due to at least two parameter configurations Sₚ, S_{q} with p, q∈{i} to treat the food to be cooked using microwaves differently in a localized manner. In this case, in the parameter configuration Sᵢ each setting parameter that is used is represented by precisely one value. In other words, a parameter configuration Sᵢ corresponds to a specific value group of different setting parameters. In one development, altogether n parameter configurations Sᵢ={S₁, . . . , Sₚ, . . . , S_{q}, . . . , Sₙ} can be set, wherein n is advantageously at least three, typically multiple tens, hundreds or even thousands.

In one embodiment, the at least one setting parameter comprises at least one setting parameter from the group:
angle of rotation of a rotary antenna,
angle of rotation of a rotary plate,
position of a mode stirrer,
microwave frequency of a semiconductor-based microwave generator,
phase difference between microwaves that are supplied into the cooking compartment from different feed-in locations (“ports”),
etc.

The rotary antenna is typically not rotationally symmetrical and is used so as to decouple or to supply microwaves from a waveguide or an HF cable into the cooking compartment. The angle of rotation of the rotary antenna can be specifically set for example by means of a stepper motor.

For example, a parameter configuration Sᵢ can have precisely one setting parameter, for example the angle of rotation φ of a rotary antenna in accordance with

Sᵢ=φᵢ i.

using φᵢ the i-th angular step from altogether n possible angular steps, for example with S₀=φ₀=0°, Sᵢ=φ₁=1°, . . . , etc. in the case of increments of Δφ=1° or S0=φ0=0°, S1=φ1=10°, . . . , etc. in the case of increments of Δφ=10°. This can apply in a similar manner for other setting parameters, for example for the microwave frequency f=[2440 MHz; 2460 MHz] having increments of 10 MHz, for a phase difference of microwaves that are fed in via different ports in the range of [80°, . . . , 120°] etc.

However, a parameter configuration Sᵢ can also have values of multiple setting parameters, for example

$$\\ \begin{matrix}{S}_{i} = ( \begin{matrix}{φ}_{j} \\ {f}_{k}\end{matrix} ) & i .\end{matrix}$$

with for example φⱼ one of the possible values of the angle of rotation φ of the rotary antenna and fₖ one of the possible values of the microwave frequency f. Different parameter configurations Sₚ and S_{q} differ in this case by at least one different value of the angle of rotation φ and/or microwave frequency f. For example, the following can then apply:

$$\\ \begin{matrix}{S}_{1} = ( \begin{matrix}0 ° \\ 2440 MHz\end{matrix} ) , & i .\end{matrix}$$

$$\\ \begin{matrix}{S}_{2} = ( \begin{matrix}1 ° \\ 2440 MHz\end{matrix} ) , & ii .\end{matrix}$$

$$\\ \begin{matrix}{S}_{360} = ( \begin{matrix}359 ° \\ 2400 MHz\end{matrix} ) , & iii .\end{matrix}$$

$$\\ \begin{matrix}{S}_{361} = ( \begin{matrix}0 ° \\ 2410 MHz\end{matrix} ) , & iv .\end{matrix}$$

The parameter configurations Sᵢ can be set by the control facility in an arbitrary sequence and increment(s).

The parameter configurations Sᵢ can be broadened in a similar manner to more than two setting parameters. The quantity of all the possible parameter configurations {Sᵢ} can correspond in particular to the quantity of the parameter configurations Sᵢ having all the commutated values of the setting parameters.

However, the control facility can also only set a specific part quantity of all the possible parameter configurations {Sᵢ}, for example the angle of rotation φᵢ of a rotary antenna in increments of ten of Δφ=10°, even if constructively a finer increment Δφ could be set, for example of Δφ=1°.

The temperature distribution <T>ᵢ≡<T(Sᵢ)> that is measured for a specific parameter configuration Sᵢ corresponds in particular to a temperature distribution that is measured during this parameter configuration Sᵢ, in particular to a temperature distribution immediately prior to switching to the next parameter configuration Sᵢ₊₁. In particular, a parameter configuration Sᵢ can be maintained for a specific period of time (“holding period”) Δt and the associated temperature distribution <T>ᵢ at the end of the holding period Δt can be measured or recorded.

The temperature distributions <T>ᵢ are spatially resolved and in other words have m spatially different (image) segments T_{i;j} with j={1, . . . , m}. In the case of m=4 segments, this can be described for example by

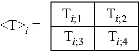

The segments can correspond for example to individual pixels of the thermal imaging sensor or averaged groups of adjacent pixels. As is already stated above, the surface of at least one food to be cooked is divided into segments, wherein the segments advantageously follow the contour of the food to be cooked. Surfaces that are not of the food to be cooked are advantageously omitted or are not taken into further consideration.

In order to perform the initial scan, advantageously it is assumed that the food to be cooked has a starting temperature that either corresponds to the room temperature or has been recently taken out of a freezing compartment and is therefore frozen. The initial scan is in other words recorded outside of a saturation phase of the food to be cooked. Alternatively, such a starting temperature can be measured by the thermal imaging sensor.

The heating patterns <ΔT>_{p,q} correspond to spatially resolved temperature differences (“rises in temperature”) between identical locations or location segments of the surface of the food to be cooked of corresponding temperature distributions <T>ₚ and <T>_{q}, in other words <ΔT>_{p,q} of the difference <T>_{q}−<T>ₚ in the above example having four segments in other words

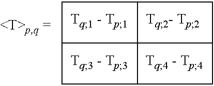

wherein advantageously the temperature distribution <T>_{q} has been recorded chronologically after <T>ₚ. More precisely, the heating patterns <ΔT>_{p,q} correspond to the difference of the temperature distributions <T>ₚ and <T>_{q}, that are provided in a microwave treatment under a succession or sequence of parameter configurations Sₚ, . . . , S_{q} that is performed.

If for example during the initial scan a rotary antenna describes a full rotation and no further setting parameters are varied, for example a heating pattern <ΔT>_{90,0} in other words corresponds to one antenna rotation or to an antenna “sweep” between the angles of rotation φ=0° and φ=90°. A time factor can also be selectively incorporated. A succession of parameter configurations Sₚ, . . . , S_{q} can then comprise how rapidly the succession is run through. For example, it is possible in order to determine the heating pattern <ΔT>_{90,0} to perform a uniform movement of the rotary antenna from angular position or angle of rotation φ=0° to angular position or angle of rotation φ=900 for example within 10 seconds, which corresponds to an angular velocity of 9°/s.

In the event of a semiconductor-based microwave generator, it is possible for an initial scan additionally or alternatively to be represented by a suitable trajectory in the frequency phase space. This can be a sequence, which is set in advance or determined dynamically, of frequency values and where applicable phase angles between different semiconductor-based microwave generators. Below, for a simplified description the method is described using a magnetron as a microwave generator and a rotary antenna as a mode stirrer. The method can however also be implemented in a similar manner for other microwave generators or methods for the field change.

The heating patterns <ΔT>_{p,q} can be calculated for arbitrary indices p and q, for example for all possible pairs of p and q or only for one part quantity thereof. The greater the time interval of the temperature distributions <T>_{q} and <T>ₚ typically the greater the values or rises in temperature of the associated segments T_{p,q;j}=T_{q,j}−T_{p,j}.

In one particularly advantageous development, the heating patterns <ΔT>_{p,q} (in particular in the case of an identical microwave power) are based on the same irradiation duration. At the same angular velocity of the rotary antenna, it is possible for this purpose for example to calculate heating patterns <ΔT>_{p,q} with the same angular interval q−p. In the case of a smallest possible increment Δϕ=1°, it is consequently possible to calculate heating patterns for one full antenna rotation up to 360. However, for a reduced computing outlay it is also possible to calculate only some heating patterns <ΔT>_{p,q} for example for all Δφ=10° the 36 heating patterns <ΔT>_{0,60}, <ΔT>_{10,70}, <ΔT>_{20,90}, . . . <ΔT>_{359,419}. In this case, <ΔT>_{p,q}=<ΔT>_{p+360,q+360} can be assumed.

The segments of the heating patterns <ΔT>_{p,q} can be indicated for example as temperature differences with units ° C. or K or as temperature differences per time unit with the units ° C./s or K/s.

The initial scan is concluded with the incorporation of the temperature distributions <T>ᵢ or <T>ₚ, <T>_{q} or with the calculation of the heating patterns <ΔT>_{p,q}.

The steps (a) to (d) that are performed after the initial scan can also be performed during a saturation phase of the food to be cooked and do not require any more additional thermal imaging captures. On the contrary, the microwave influence is performed with the aid of the quantity of heating patterns <ΔT> that are calculated and stored during the initial scan. This utilizes the knowledge that the quantity of energy and energy distribution that is introduced into the food to be cooked under a specific parameter configuration Sᵢ in the saturation state corresponds particularly closely to the quantity of energy and energy distribution that is introduced into the food to be cooked under the same parameter configuration Sᵢ during the warming up phase even if this is no longer represented in the saturation state by a temperature increase.

For such a microwave influence, after the initial scan in step (a) a desired standardized (temperature) target distribution <Z> is set. This corresponds to a desired relative (“standardized”) temperature distribution over the surface of the food to be cooked. In the event of the above example, for example the standardized target distribution <Z> can be set in the case of a desired homogenous temperature distribution on the surface of the food to be cooked as

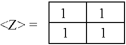

which for example can be advantageous for defrosting, in particular for defrosting food to be cooked that is to a large extent homogenous such as minced meat, tray cake, lasagna etc. In this case, ideally each element of the food to be cooked is to be influenced with the same quantity of energy.

However, in general inhomogeneous standardized target distributions <Z> can also be set, for example.

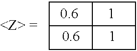

This scenario is particularly suitable for example for complete defrosting dishes. Thus the elements having the weighting “0.6” can contain mashed potato, the elements having the weighting “1” a roulade. Since the mashed potato requires less energy than a solid piece of meat to defrost, a corresponding weighting is performed. In another example, the elements having the weighting “0.6” can contain asparagus, the elements having the weighting “1” can contain potatoes. Since the asparagus reacts clearly in a more sensitive manner to overcooking, the heating is thus performed more cautiously while the potatoes are influenced using more energy. The water proportion of the food to be cooked is relevant for the required energy since this water proportion determines the energy requirement due to the phase transition. The values can be determined empirically for example and depend for example on the type of the microwave treatment (defrosting, cooking, etc.) and/or the type of the food to be cooked. A suitable standardized target distribution <Z> can be selected for example by automatic recognition of the food to be cooked (for example by means of a camera) and comparison of the food to be cooked that is identified with weighting values from a data bank.

By means of the desired standardized target distribution <Z> it is possible together with the prevailing temperature distribution <T> of the food to be cooked to set or calculate at least one target temperature distribution <T_{target}>, <T_{target}*>_{p,q} for the food to be cooked. The “at least one target temperature distribution <T_{target}>, <T_{target}*>_{p,q} can comprise for example only one target temperature distribution <T_{target}> or one target temperature distribution <T_{target}> and multiple target temperature distributions <T_{target}*>_{p,q}.

In one embodiment, the target temperature distribution <T_{target}> is calculated as a product of the desired standardized target distribution <Z> with an average (scalar) temperature T̅ of the prevailing temperature distribution <T>, in other words in accordance with <T_{target}>=T̅·<Z>.

The average temperature T̅ of a temperature distribution <T> can be calculated as an average of the m associated segments Tⱼ in other words in accordance with

$$\\ \begin{matrix}\overline{T} = \frac{1}{m} {\sum }_{j = 1}^{m} {T}_{j} & i .\end{matrix}$$

In one embodiment, the target temperature distribution <T_{target}*>_{p,q} is calculated as a product of the desired target state <Z> using an average or average value of the temperature T̅_{p,q} of the prevailing temperature distribution <T> plus a heating pattern <ΔT>_{p,q} in other words in accordance with

<T_{target}*>_{p,q}=T̅_{p,q}·<Z> i.

using T̅_{p,q} of the average temperature from the prevailing temperature distribution <T> plus the heating pattern <ΔT>_{p,q} averaged over the associated segments. T̅_{p,q} can be calculated for m associated segments in other words in accordance with

$$\\ \begin{matrix}{\overline{T}}_{p , q} = \overline{T} + {\overline{Δ T}}_{p , q} = \frac{1}{m} {\sum }_{j = 1}^{m} {T}_{j} + \frac{1}{m} {\sum }_{j = 1}^{m} Δ {T}_{p , q ; j} = \frac{1}{m} {\sum }_{j = 1}^{m} ( {T}_{j} + Δ {T}_{p , q ; j} ) & i .\end{matrix}$$

In step (b) a heating pattern <ΔT>_{p,q|best} is now determined from the group or quantity of the heating patterns {<ΔT>_{p,q}} that are previously obtained from the initial scan by means of which the at least one target temperature distribution <T_{target}>, <T_{target}*>_{p,q} can be best approximated based on the prevailing temperature distribution <T> in other words which is best suited for achieving the target temperature distribution <T_{target}>. Such a determination or selection can be performed for example by means of evaluating values B or B_{p,q} as is described more precisely below.

For step (d), owing to the linear relationship between the microwave power that is emitted and the rise in temperature, it is assumed that the “new” temperature distribution <T>_{new} that is present after this influence of microwaves corresponds to a linear addition of the temperature distribution <T> old that was present beforehand (old) and the heating pattern <ΔT>_{p,q|best} in other words

<T>_{new}=<T>_{old}+<ΔT>_{p,q|best} i.

applies, which can also be written iteratively as <T>:=<T>+<ΔT>_{p,q|best}. The new temperature distribution <T>_{new} is also considered below as a “virtual” temperature distribution since it is no longer measured but rather has been calculated. During a warming up phase, a “virtual” temperature distribution corresponds to a particularly close approximation of the actual temperature distribution, conversely not during a saturation phase. The ability to apply the linear addition amounts to a surprising finding that the heating patterns <ΔT>_{p,q} do not undergo any significant change as long as the phase transition during a saturation phase (for example, solid->liquid or liquid->gaseous) is not concluded in at least one location in the food to be cooked. This can also be expressed in other words so that the electrodynamic impedance state in the cooking compartment remains constant during the defrosting procedure or cooking procedure. In other words, if a specific parameter configuration (antenna position, frequency, phase, . . . ) can be reset in a reproducible manner, within the cooking compartment a practically identical field distribution and consequently a practically identical heating distribution in the food to be cooked is also established again. The heating patterns <ΔT>_{p,q} can therefore be combined in a suitable manner in order to render possible as uniform an introduction of energy into the food to be cooked as possible and thereby a targeted (for example homogenous) defrosting or cooking.

In one embodiment, the steps (a) to (d) are repeated until the prevailing temperature distribution <T> or <T>_{new} meets a predetermined cancellation criterion. As a consequence, the food to be cooked can be heated advantageously in an iterative or incremental manner taking into consideration the desired standardized target state <Z> in each iteration step until the cancellation criterion is met or until the microwave treatment procedure is terminated. Thus the advantage is achieved that a target temperature distribution of food to be cooked that is in its saturation state can be particularly reliably set even without prevailing temperature measurements. The “virtual temperature distribution” in the saturation state of the food to be cooked does not correspond to the actual temperature distribution (that scarcely changes in the saturation state), but rather to a temperature distribution that would have resulted if the surface temperature would have been increased in a linear manner with the microwave power that is introduced as determined in the initial scan. Outside of the saturation state, the virtual temperature distribution however corresponds frequently with particularly effective accuracy to the actual temperature distribution of the food to be cooked with the result that this embodiment also achieves an effective target temperature distribution if the saturation state/the saturation phase is not yet reached with the termination of the initial scan (the initial scan in other words does not last so long that with its end the saturation state has already been reached).

The “prevailing” temperature distribution <T> that is assumed in the steps (a) to (d) corresponds, in particular after termination of the initial scan, to the last-measured temperature distribution otherwise the last calculated virtual temperature distribution.

In one embodiment, the cancellation criterion comprises that the prevailing temperature distribution <T> reaches or exceeds a predetermined limit temperature Tₗᵢₘᵢₜ.

The limit temperature Tₗᵢₘᵢₜ can be a real end temperature of the food to be cooked, which is requested by a user or a cooking program, for example 0° in the case of defrosting or values greater than 0° C. for a heating procedure of the food to be cooked, for example to a consumption temperature of 60° C. Alternatively, the limit temperature Tₗᵢₘᵢₜ for the present method can be an automatically calculated “virtual” limit temperature that can be derived from a cooking state of the food to be cooked, which is determined by a user or a cooking program, (for example, “defrosted” or “cooked”).

Thus in one embodiment, the (virtual) limit temperature Tₗᵢₘᵢₜ is calculated from a quantity of energy that is required in order to perform a (complete or partial) phase transformation, in particular of water, in the food to be cooked. As a consequence, the advantage is achieved that the quantity of heat that corresponds to the phase transition enthalpy can be introduced particularly precisely into the food to be cooked even without continuous monitoring of the temperature of the food to be cooked. In this case, the fact that it is possible to particularly effectively approximate how far the introduction of the phase transition enthalpy has already progressed via the virtual temperature distributions is utilized. In particular, this is advantageous in order to achieve a state of the food to be cooked that is as completely defrosted as possible without the food to be cooked being further heated. This is to be explained in the following example of defrosting minced meat:

Mixed minced meat is approximately 30% fat, 20% protein and 50% water. It is possible to derive therefrom key figures of the specific heat c_{w} in the frozen state, namely

c_{w}(ice)≈2.1 J/(g·K); c_{w}(protein)≈1.7 J/(g·K); c_{w}(fat)≈1.9 J/(g·K)

and thus

c_{w}(minced meat,frozen)≈(0.5·2.1+0.2·1.7+0.3·1.9)J/(g·K)=1.96 J/(g·K)˜2 J/(g·K)

The defrosting procedure is determined largely by the enthalpy of fusion of the water proportion of h=334 J/g. The solidification heat of fat has a negligible influence. The enthalpy of fusion h of minced meat is therefore:

h (minced meat,frozen)≈0.5·334 J/g=167 J/g

In order to defrost 1 g of minced meat from the frozen state at for example −18° C. to 0° C., a quantity of energy of 18-2 J=36 J is required for the rise in temperature to 0° C. and also 167 J for the application of the enthalpy of fusion, altogether in other words 203 J. The microwave energy that is absorbed, which in the heating up phase has led to a temperature increase of the food to be cooked, is entirely supplied to the phase transition during the defrosting procedure in the saturation state. This principle likewise applies for the consideration of the virtual temperature distribution.

In purely computational terms, the virtual temperature T of minced meat must be increased by altogether

[203 (J/g)]/[2 J/(g·K)]=101.5 K

in order to conclude the defrosting process. This corresponds to a virtual limit temperature Tₗᵢₘᵢₜ. Since the virtual temperature can be calculated from the measured rises in temperature during the linear heating phase in a computationally simple manner and independent of the enthalpy of fusion that is introduced and that is not measurable, it is possible to achieve a highly homogenous defrosting result if as simultaneously as possible a value of T=101.5 is achieved in all the local regions of the virtual temperature distribution <T>. The virtual limit temperature Tₗᵢₘᵢₜ can deviate in dependence upon the food to be defrosted, for example the virtual limit temperature will be higher for water-rich vegetables or fruit.

This determination of a virtual limit temperature Tₗᵢₘᵢₜ has a particularly high tolerance with respect to fluctuations of the mass and/or the shape of the food to be cooked during a microwave treatment since in contrast with conventional defrosting programs having a mass specification by the user, here the algorithm proceeds independently and adaptively and reaches the limit temperature Tₗᵢₘᵢₜ without previous specification of the mass. That is in particular advantageous if the shaping of the food to be defrosted deviates from usual shapes and for example tapered edges would promote excessive overheating.

In one embodiment, in addition to the steps (a) to (d) by means of the at least one thermal imaging sensor a temperature distribution <T>ₘₑₐₛ of the food to be cooked is recorded and comprises the cancellation criterion that the measured temperature distribution <T>ₘₑₐₛ reaches a predetermined real limit temperature Tₗᵢₘᵢₜ. In particular, the at least one thermal imaging sensor after the initial scan can capture further thermal images of the food to be cooked (in other words further monitor the temperature distribution of the food to be cooked) without this however going into the iterative setting of the microwave field distribution according to steps (a) to (c). Due to this embodiment, the advantage is achieved that a specific state of the food to be cooked is reached in a particularly reliable manner and can even then be set if an introduction of energy into the food to be cooked does not just take place due to microwave radiation but rather also due to other effects (“side effects”) such as for example the heating of the food to be cooked in a microwave appliance that is at least at room temperature. The real temperature that is reached of the food to be cooked then lies in general slightly above the prevailing temperature distribution <T> that is calculated. A continuous monitoring by a thermal imaging sensor in practice is therefore for example advantageous in order to identify premature defrosting due to side effects (for example due to identifying a measured temperature in a thermal image segment of more than 0° C.) and then to interrupt the microwave treatment procedure.

The fact that the prevailing temperature distribution <T> or the measured temperature distribution <T>ₘₑₐₛ reaches or exceeds a predetermined limit temperature Tₗᵢₘᵢₜ includes in particular that only one segment, multiple segments, all the segments or an average value of the segments of the prevailing temperature distribution <T> or the measured temperature distribution <T>ₘₑₐₛ reaches or reach the virtual limit temperature Tₗᵢₘᵢₜ.

In one embodiment, the initial scan is started following a tuning phase of the microwave generator, in particular magnetron, wherein
a heating pattern <ΔT>ₑₛ is recorded as the difference between a temperature distribution <T>_{es|begin} at the beginning of the tuning phase and a temperature distribution <T>_{es|end} at the end of the tuning phase,
a segment T_{es;max}, which has a highest local temperature increase, is determined from the heating pattern <ΔT>ₑₛ
a maximum duration Δt_{init;max} of the initial phase until reaching a phase transition of water in the food to be cooked is determined from the segment T_{es;max} and then
the duration Δt_{init;} of the initial phase is set with the result that the duration does not exceed the maximum duration.

It is thus advantageously ensured that the initial scan is only performed within the warming up phase or outside of the saturation period. The tuning phase of the magnetron is not used to record temperature distributions since although HF energy is already output, the magnetron during its warming up phase is however not operating in a frequency stable manner and thus a reproducible heating pattern does not occur.

In particular, it is useful to relate the heating pattern <ΔT>ₑₛ and the duration ΔTᵢₙᵢₜ of the initial scan in an indirectly proportional manner: food to be cooked that has double the rise in temperature in the tuning phase requires only half of the duration ΔTᵢₙᵢₜ of the initial scan. For example, a small portion of food to be cooked of 250 g has an average heating in the tuning phase of 3.0° C., while a large portion of the same food to be cooked of 500 g is heated by 1.5° C. The duration ΔTᵢₙᵢₜ of the initial scan can then be set for example to 15 seconds for the small portion and 30 seconds for the large portion. Advantageously this results in the heating patterns in all cases having approximately the same temperature amounts and thus a particularly advantageous ratio of low noise pattern recording and the largest possible remaining temperature range for optimizing the temperature distribution.

Reaching the phase transition of water in the food can represent the temperature at which presumably phase transitions take place. For defrosting, reaching the phase transition for example can correspond to reaching a temperature of 0°, in the case of a cooking procedure this can correspond to reaching a boiling temperature of typically 100° C.

Reaching the phase transition can also comprise a safety margin, which provides the advantage that an initial scan is particularly reliably avoided in the case of phase transitions that are already locally noticeable. The safety margin can be for example 2° C. with the result that then for example from the segment <ΔT>_{es,max} a maximum duration of the initial phase is determined until a temperature of −2° C. is reached.

The duration of the initial phase, which is then actually set, does not exceed the maximum duration. The duration of the initial phase, which is actually set can be noticeably shorter than the duration for reaching the phase transition, in particular for warming up procedures to consumption temperature. This provides the advantage that on the one hand a low-noise recording of the heating pattern <ΔT>_{p,q} is rendered possible during the initial scan, on the other hand a rise in temperature that is still sufficient occurs until the target temperature is reached in order to perform the actual heating procedure with the aid of the heating patterns <ΔT>_{p,q}. For example, if a meal that has been taken from the fridge having a temperature of 5° C. is to be heated to 60° C., it is possible after the initial scan for a maximum temperature of for example 20° C. to occur. In the case of the desired real limit temperature for consumption at 60° C. a rise in temperature of 40° C. thus remains available for the optimization of the introduction of temperature.

In one embodiment, in step (a) the target temperature distribution is calculated in accordance with

<T_{target}>=T̅·<Z>
using T̅ of the average temperature from the prevailing temperature distribution <T> averaged over the associated segments, and in step (b) in order to determine the heating pattern <T>_{p,q|best} that is most suitable
for each selected heating pattern <ΔT>_{p,q} an evaluating value B_{p,q} is calculated in accordance with

B_{p,q}=Σ(|<T_{target}>−<T>|^{d}−|<T_{target}>−(<T>+<ΔT>_{p,q})|^{d})

(a) and
the heating pattern <ΔT>_{p,q} for which the evaluating value B_{p,q} assumes the highest value is selected as the most suitable heating pattern <ΔT>_{p,q|best}.

It is thus advantageously possible to provide a particularly rapid and reliable possibility for determining the most suitable heating pattern <T>_{p,q|best}. This embodiment is particularly advantageous if differences in the individual segments of the prevailing temperature distribution <T> are rather small.

The above formula for the calculation of the evaluating value B_{p,q} can also be written in relation to segments over j=1, . . . , m segments as

$$\\ {B}_{p , q} = {\sum }_{j = 1}^{m} ( {\vert {T}_{target ; j} - {T}_{j} \vert}^{d} - {\vert {T}_{target ; j} - ( {T}_{j} + Δ {T}_{p , q ; j} ) \vert}^{d} )$$

In one embodiment, in step (a) a first target temperature distribution <T_{target}> is calculated in accordance with

<T_{target}>=T̅·<Z>
using T̅ of the average temperature from the prevailing temperature distribution <T> averaged over the associated segments and for all the selected heating patterns <ΔT>_{p,q} a respective second target temperature distribution <T_{target}*>_{p,q} is calculated in accordance with

<T_{target}*>_{p,q}=T̅_{p,q}·<Z>
using T̅_{p,q} of the average temperature from the prevailing temperature distribution <T> plus the selected heating pattern <ΔT>_{p,q} averaged over the associated segments (in other words T̅_{p,q}=<T>+<ΔT>_{p,q}) and in step (b) in order to determine the heating pattern <T>_{p,q|best} that is most suitable
for each selected heating pattern <ΔT>_{p,q} an evaluating value B_{p,q} is calculated in accordance with

B_{p,q}=Σ(|<T_{target}>−<T>|^{d}−|<T_{target}>−(<T>+<ΔT>_{p,q})|^{d})

(a) and
the heating pattern <ΔT>_{p,q} for which the evaluating value B_{p,q} assumes the highest value is selected as the most suitable heating pattern <ΔT>_{p,q|best}.

It is thus likewise possible to provide a particularly rapid and reliable possibility for determining the most suitable heating pattern <T>_{p,q|best}. This embodiment is particularly advantageous if differences in the individual segments of the prevailing temperature distribution <T> are rather large.

The above formula for the calculation of the evaluating value B_{p,q} can also be written in relation to segments over j=1, . . . , m segments as

$$\\ {B}_{p , q} = {\sum }_{j = 1}^{m} ( {\vert {T}_{target ; j} - {T}_{j} \vert}^{d} - {\vert {T}_{target ; j}^{*} - ( {T}_{j} + Δ {T}_{p , q ; j} ) \vert}^{d} )$$

In one development, it is possible to switch between the two methods for calculating the evaluating values and thus for determining the most suitable heating pattern <T>_{p,q|best}, for example based on the largest value difference of the segments of the prevailing temperature distribution <T>. If this largest value difference for example lies below a predetermined threshold value, the first embodiment described above is used, otherwise the latter embodiment described above is used.

The exponent value d determines how much deviations from the target state are taken into consideration. In the case of d>1 heating pattern <ΔT>_{p,q} will be preferred which compensate greater differences of the prevailing temperature distribution <T> with respect to the target state <Z>.

The evaluating values B_{p,q} in general apply the focus during the progress of the microwave treatment process to the avoidance of hotspots. It can be advantageous during the microwave treatment process to apply a higher weighting to the heating of cold sites even if this leads to loads of overheated regions. This can be realized in that the exponent value d is adapted in dependence upon the ratio of <T_{target}> to <T> in a segment-by-segment manner.

For example, in the case of the above segment-related calculating formulae for the evaluating values B_{p,q} for a j-th segment in the associated sum term the exponent value d=d1 can be set, in the event that T_{target;j}>Tⱼ applies, the j-th segment of the prevailing temperature distribution <T> is in other words colder than the same segment of the target temperature distribution <T_{target}>. In the event that T_{target;j}<Tⱼ applies, the j-th segment of the prevailing temperature distribution <T> is in other words warmer than the same segment of the target temperature distribution <T_{target}>, the exponent value d=d2 is set, wherein d1>d2 applies. The evaluating value B_{p,q} weights the “filling” of cold sinks more heavily than the avoidance of hotspots when d=d2.

It is possible to perform this segment-by-segment variation with each calculation of the evaluating value B_{p,q} or only each n-th time (with n>2).

In one embodiment, the food to be cooked that is introduced into the cooking compartment is frozen food to be cooked. The phase transition corresponds then to the phase transition from solid to liquid, the warming up phase takes place in the frozen state of the food to be cooked and the saturation state of the food to be cooked corresponds to a state in which in the food to be cooked locally noticeable phase transitions from solid to liquid take place. In the case of this embodiment, in other words food to be cooked can be removed from a freezer compartment and brought into a cooking compartment of the microwave cooking appliance. With the start of a treatment procedure for example initially a tuning phase of the microwave generator is performed, then the maximum possible duration of the initial scan is calculated until reaching the melting temperature of water (where applicable minus a safety interval), the actual duration of the initial scan is subsequently set, then the initial scan is performed for the set duration and then the food to be cooked is influenced using microwaves with the aid of the heating pattern that is determined by the initial scan until the food to be cooked is as completely defrosted as possible.

In one alternative or additional embodiment, the food to be cooked that is introduced into the cooking compartment is not frozen food to be cooked. The phase transition corresponds then to the phase transition from liquid to gaseous, the warming up phase takes place in a non-frozen state of the food to be cooked and the saturation state of the food to be cooked corresponds to a state in which locally noticeable phase transitions from liquid to gaseous are already taking place in the food to be cooked. In the case of this embodiment, in other words non-frozen food to be cooked can be brought into a cooking compartment of the microwave appliance. With the start of a treatment procedure, for example initially an activation phase of the microwave generator is started, then the maximum possible duration of the initial scan is calculated, the actual duration of the initial scan is subsequently set, then the initial scan is carried out for the set duration and then the food to be cooked is influenced using microwaves with the aid of the heating pattern that is determined by the initial scan until a desired cooking state is reached, for example part or entirely cooked.

In general, the above method can be implemented for any cooking states or limit temperatures. As is already indicated above, the method can be implemented for example until a state of the food to be cooked in which the food to be cooked is just completely defrosted. In the example of minced meat, this can be advantageous in order to process it by machine. Alternatively, frozen food to be cooked can be specifically heated above its defrosted state, for example so as to warm up to room temperature or until cooking. In the example of minced meat, warming up to room temperature can be for example advantageous in order to process by hand.

In particular, the method can be implemented multiple times, for example twice successively, for example initially so as to defrost food to be cooked and then again so as to cook.

In one embodiment that is in particular advantageous for cooking food to be cooked, after multiple repetitions of the steps (a) to (d) an initial scan is performed again and steps (a) to (d) are subsequently repeated based on the newly implemented initial scan.

The object is also achieved by a household microwave appliance having a cooking compartment, which can be loaded with food to be cooked, a microwave generator for generating microwaves by means of which it is possible to influence the food to be cooked, which is located in the cooking compartment, at least one thermal imaging sensor, which is oriented into the cooking compartment, for determining temperature distributions, <T>, on a surface of the food to be cooked and a control facility that is configured so as to set multiple parameter configurations Sₚ, S_{q} of setting parameters of the household microwave appliance, wherein due to at least two parameter configurations Sₚ, S_{q} the food to be cooked can be treated differently in a localized manner using microwaves, wherein the household microwave appliance is configured so as to implement the method that is described above. The household microwave appliance can be designed in a similar manner to the method and has the same advantages.

The above-described characteristics, features and advantages of this invention and also the manner in which these are achieved become clearer and more clearly understandable in conjunction with the following schematic description of an exemplary embodiment that is further explained in conjunction with the drawings.

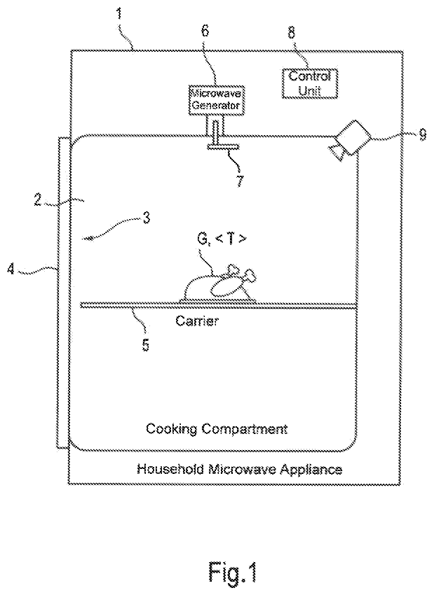

FIG. 1 shows a simplified sketch of a household microwave appliance that is configured so as to implement the method that is described above;

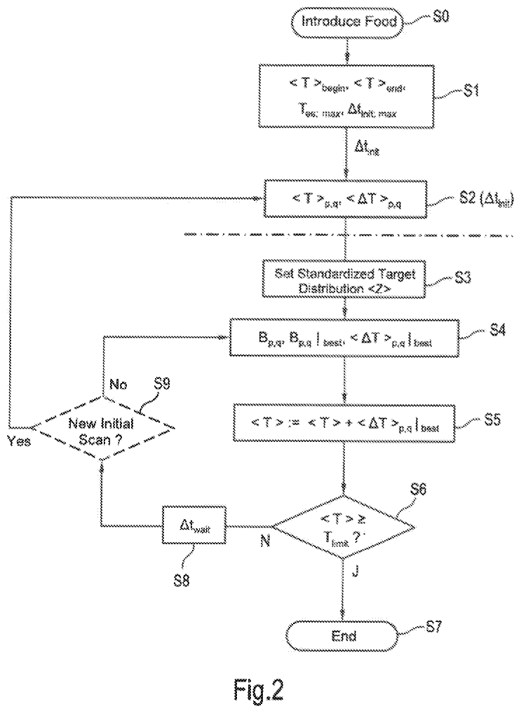

FIG. 2 shows various sequential steps of a possible exemplary embodiment of the method that is described above and

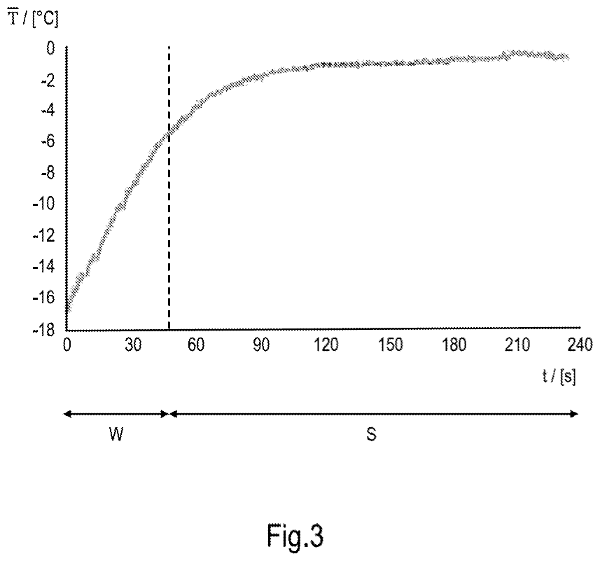

FIG. 3 shows a temporal progression of an average surface temperature of food to be cooked during a defrosting procedure during constant influencing using microwave power.

FIG. 1 illustrates as a sectional view in a side view a sketch of a household microwave appliance in the form of a microwave appliance 1 that is configured so as to implement the method that is further described in FIG. 2. The microwave appliance 1 has a cooking compartment 2 having a front-side loading hatch 3 that can be closed by means of a door 4. Food to be cooked G is arranged on a carrier 5 for food to be cooked in the cooking compartment 2.

The household microwave appliance 1 moreover has at least one treatment unit for food to be cooked in the form of a microwave generating facility 6. The microwave generating facility 6 can have for example an inverter-controlled microwave generator, a rotary antenna 7, which can be adjusted in rotation and/or height, and/or a wobbler (not illustrated), which can be adjusted in rotation and/or height. In addition, the microwave appliance 1 can have infrared radiating heating bodies (not illustrated), for example a bottom heat heating body, a top heat heating body and/or a grill heating body.

The microwave generating facility 6 is controlled by means of a control unit 8. In particular, the microwave generating facility 6 can be set to at least two parameter configurations Sₚ, S_{q} having different field distributions in the cooking compartment 2. Different parameter configurations Sₚ, S_{q} can correspond for example to different values φᵢ of an angle of rotation φ of the rotary antenna 7. The angle of rotation φ consequently corresponds to a field-varied setting parameter or operating parameter of the microwave appliance 1 having at least two setting values (i. In particular, the rotary antenna 7 can rotate continuously, for example in increments Δφ=1° with the result that n=360 angle of rotation values (i can be set, in particular individually.

The control unit 8 is moreover connected to an optical sensor in the form of a thermal imaging camera 9. The thermal imaging camera 9 is arranged so that it is oriented into the cooking compartment 2 and can record a pixelated thermal image of the food to be cooked G. As a consequence, the thermal imaging camera 9 can be used so as to record or determine a temperature distribution <T> on the surface of the food to be cooked G.

The control unit 8 can moreover be configured so as to implement the method that is described above and also so as to be used as an evaluating facility. Alternatively, the evaluation can run on an instance that is external to the appliance such as a network computer or the so-called “cloud” (not illustrated).

FIG. 2 illustrates various sequential steps of a possible exemplary embodiment of the method that is described above with the aid of the microwave appliance 1 in FIG. 1.

In one step S0, food to be cooked G is introduced into the cooking compartment 2 for treatment using microwaves. The food to be cooked G can be frozen or not frozen.

In step S1, a microwave treatment procedure is started for which the microwave generator 6 is activated. For this purpose, initially a tuning phase of the microwave generator 6 is waited for, for example for tₑₛ=10 s, in order to bring this microwave generator into a tuned or stable operating state. During the tuning phase, the rotary antenna 7 rotates continuously or quasi-continuously, for example with increments Δφ=1°.

At the start of the tuning phase, an image of a heat distribution <T>_{begin} of the surface of the food to be cooked G is captured by means of the thermal imaging camera 9, with the conclusion of the activation phase an image of a heat distribution <T>_{end} of the surface of the food to be cooked G is captured. The heat distributions <T>_{begin} and <T>_{end} in each case have m surface segments, for example m pixels or m averaged groups of adjacent pixels.

In step S1, a heating pattern <ΔT>ₑₛ is subsequently calculated as the difference of the m surface segments in accordance with <ΔT>ₑₛ=<T>_{end}−<T>_{begin} and the segment ΔT>_{es;max} having the maximum rise in temperature is ascertained therefrom. If the food to be cooked G is frozen for example at −24° C. and is to be defrosted, the heat distributions and <T>_{begin} and <T>_{end} in the four segments can appear for example as follows (temperature values in ° C.)

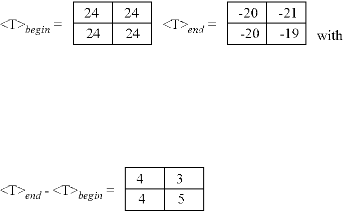

and thus ΔT_{es;max}=5° C.

Subsequently, in order to determine a maximum possible duration t_{init,max} for the following initial scan it is assumed that the initial scan is to be performed at most until a surface region of the food to be cooked G reaches the freezing point of water, minus a safety temperature interval of for example 2° C., in other words does not exceed −2° C. As a consequence, it is ensured that the initial scan is only performed during the warming up phase of the food to be cooked G and while the food to be cooked G is not yet in its saturation state, in other words is not yet locally in its phase transition state or saturation state anywhere.

Based on the maximum rise in temperature ΔT_{es;max}=5° C., the maximum possible duration Δt_{init;max} of the initial scan is determined as

$$\\ Δ {t}_{init ; max} = \frac{( - 2 ° C . - ( - 19 ° C . ) ) \cdot {t}_{es}}{{T}_{es , max}} = \frac{17 ° C . \cdot 10 s}{5 ° C .} = 34 s$$

For the initial scan, a time period Δtᵢₙᵢₜ of 34 s can be set whereby a particularly effective resolution/low thermal noise of the heat distributions that are then captured by means of the thermal imaging camera 9 are provided.

It is however also possible that smaller durations Δtᵢₙᵢₜ than 34 s already suffice in order to obtain an effective resolution/a low thermal noise, for example between 5 s and 10 s, and the duration Δtᵢₙᵢₜ for implementing the initial scan is set to such a lower duration.

For the example explanation of the method sequence, it is to be assumed below that the duration of the initial scan is set to Δtᵢₙᵢₜ=10 s.

In step S2, an exemplary initial scan is performed in that microwaves having a constant power are supplied into the cooking compartment 2 for tᵢₙᵢₜ=10 s in the case of a continuously or quasi-continuously (for example with an increment Δφ=1°) rotating rotary antenna 7. The rotary antenna 7 in this case advantageously performs at least one full rotation between φ=0° and φ=360°, however can also be rotated further.

The thermal imaging camera 9 during or after each angle of rotation φ that is set or during or after each angular sector Δφ (for example for all Δφ=10°) captures an image of a heat distribution of the food to be cooked G having in each case m segments. Under the exemplary assumption that only the angle of rotation φ is varied as a setting parameter, for example for the full rotation of the rotary antenna 7 the parameter configurations S₀=0°, S₁=1°, . . . , S₃₅₉=359° result.

The corresponding temperature distributions <T>(Sᵢ)≡<T>(φᵢ)≡<T>ᵢ can appear for example as follows (with <T>₀=<T>_{end} and values in ° C.):

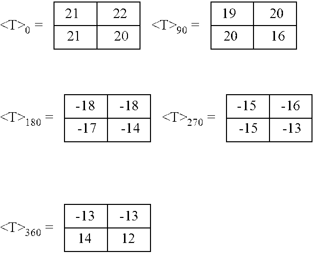

etc. wherein the rises in temperature starting from <T>₀ become greater the further the rotary antenna 7 rotates. In this case, it is to be noted that the temperature distributions <T>ᵢ at different angles of rotation (i locally do not generally change uniformly since the associated field distributions of the microwaves in the cooking compartment 2 are not uniform but rather for example hot spots stated above can form in dependence upon the angle of rotation.

In step S2, moreover corresponding distributions of temperature changes or rises in temperature (“heating patterns”)<ΔT>_{p,q} that result in the case of an antenna rotation between a parameter configuration Sₚ and a parameter configuration S_{q} (here: between different angles of rotation φₚ and φ_{q}) can be calculated from the temperature distributions, in the present example for example

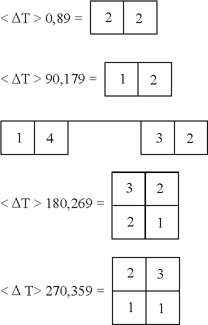

etc., wherein <ΔT>_{p,q} is calculated in accordance with <ΔT>_{p,q}=<T_{q}>−<Tₚ>.

The further apart Sₚ and S_{q} or p and q are from one another, the higher in general the associated rise in temperature of the segments. In the above examples, it is therefore assumed in a simplified manner that the rises in temperature between two angles φᵢ and φᵢ₊₁ are practically negligible with the result that for example <ΔT>_{0.89} for practical considerations can be represented by <ΔT>_{0.89} etc.

In general, heating patterns <ΔT>_{p,q} can be calculated using arbitrary values p and q. It is possible for example to calculate heating patterns <ΔT>_{p,q} for all the possible pairs of Sₚ and S_{q} or p and q or it is possible to calculate heating patterns <ΔT>_{p,q} only for selected pairs of Sₚ and S_{q} or p and q, for example having a specific interval and namely also overlapping, for example <ΔT>_{0,29}<ΔT>_{10,39}, <ΔT>_{20,49}, . . . , etc., <ΔT>_{0,59}, <ΔT>_{10,69}, <ΔT>_{20,79}, . . . , etc.

The initial scan is thus concluded. The prevailing temperature distribution of the food to be cooked G at the end of the initial scan, in the above example if the rotary antenna 7 has only been rotated to φ=3600 (in other words has only performed precisely one full antenna rotation), corresponds to the temperature distribution <T_{360°}>.

In a step S3, the desired standardized target distribution <Z> is set, for defrosting in the above example for example a (here to a standardized) homogenous target distribution <Z> with

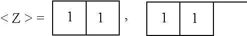

wherein <Z> in general—for example for a cooking procedure in lieu of a defrosting procedure—can also be inhomogeneous.

In a step S4, it is determined which heating pattern <ΔT>_{p,q} that is determined by means of the initial scan must be added to the prevailing temperature distribution <T> in order to obtain a best approximation of the desired standardized target distribution <Z>. Below, two variants are described for how the most suitable heating patterns <ΔT>_{p,q|best} can be determined:

1^{st} Variant

The average T of the segments of the prevailing temperature distribution <T> is formed, in the above example after the initial scan T̅=(−13° C.−13° C.−14° C.−12° C.)/4=−13° C. and the non-standardized target temperature distribution <T_{target}> that is used for the prevailing iteration step is determined therefrom in accordance with

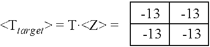

Evaluating values B_{p,q} are subsequently calculated for all or only selected heating patterns <ΔT>_{p,q} and the evaluating values for this purpose represent a measure for how good or suitable the associated heating pattern <ΔT>_{p,q} is based on the prevailing temperature distribution <T> for achieving the non-standardized target temperature distribution <T_{target}>.

The evaluating values B_{p,q} can be calculated for example in accordance with the formula

B_{p,q}=Σ(|<T_{target}>−<T>|^{d}−|<T_{target}>−(<T>+<ΔT>_{p,q})|^{d})

The above formula can be written in segment-related representation as

$$\\ {B}_{p , q} = {\sum }_{j = 1}^{m} ( {\vert {T}_{target ; j} - {T}_{j} \vert}^{d} - {\vert {T}_{target ; j} - ( {T}_{j} + Δ {T}_{p , q ; j} ) \vert}^{d} )$$

using m the number of the segments. In this case, the greater the value of B_{p,q} the better the target temperature distribution <T_{target}> is approximated.

The value of the exponent d is a preset value that determines how much deviations from the target temperature distribution <T_{target}> are taken into consideration. For d>1 it follows that the evaluating value B_{p,q} prefers such heating patterns <ΔT>_{p,q} that compensate for the large differences of the prevailing temperature distribution <T> to the target distribution <T_{target}>. The most suitable evaluating value B_{p,q|best} then corresponds in other words to the largest calculated evaluating value B_{p,q} and the most suitable heating pattern <ΔT>_{p,q|best} is the heating pattern that is associated with the evaluating value B_{p,q|best}.

2. Variant

In addition to the target temperature distribution <T_{target}> that is also calculated in the first variant, for each selected heating pattern <ΔT>_{p,q} a further target temperature distribution <T_{target}*>_{p,q}=T̅_{p,q}·<Z> is formed, wherein T̅_{p,q} is calculated from the prevailing temperature distribution <T> plus the selected heating pattern <ΔT>_{p,q} averaged over the associated segments.

An evaluating value B_{p,q} is subsequently calculated for each selected heating pattern <ΔT>_{p,q} in accordance with

B_{p,q}=Σ(|<T_{target}>_{p,q}−<T>|^{d}−|<T_{target}*>−(<T>+<ΔT>_{p,q})|^{d})

and the heating pattern <ΔT>_{p,q} for which the evaluating value B_{p,q} assumes the highest value B_{p,q|best} is selected as the most suitable heating pattern <T>_{p,q|best}.

As already indicated above, the exponent value d can be set independent of segment or can be varied in dependence upon the segment (for example in accordance with d=d1 or d=d2). Optionally, step S4 can be calculated using a segment-dependent exponent value d with every nth pass, otherwise using an exponent value d that is independent of segment.

In a subsequent step S5, for the two variants the prevailing temperature distribution <T> is increased by the most suitable heating pattern <T>_{p,q|best} in other words written iteratively in accordance with

<T>:=<T>+<ΔT>_{p,q|best},

and the thus increased temperature distribution represents the new prevailing temperature distribution <T>. The new prevailing temperature distribution <T> is a virtual temperature distribution that has been determined in a purely computational manner and does not need to match the actual temperature distribution.

Prior to or after the computerized determination of the new prevailing temperature distribution <T>, in step S5 the food to be cooked G or the cooking compartment 2 is influenced using microwaves under the succession or sequence of parameter configurations Sₚ, . . . , S_{q} using microwaves, which corresponds to the most suitable heating pattern <T>_{p,q}| best.

In a step S6, a check is performed as to whether the (new) prevailing temperature distribution <T> reaches or exceeds a predetermined limit temperature Tₗᵢₘᵢₜ. This can include checking whether a segment, some segments (for example more than 50% of the segments) or all the segments of the prevailing temperature distribution <T> reach or exceed the predetermined limit temperature Tₗᵢₘᵢₜ. If this is not the case, (“N”), the method branches to step S4. However, if this is the case (“J”), the microwave treatment procedure is terminated in step S7.

Optionally, for the case that the prevailing temperature distribution <T> has not yet reached or exceeded the predetermined limit temperature Tₗᵢₘᵢₜ, following step S5 in a step S8 it is possible for the food to be cooked G to not be influenced using microwave energy for a specific period of time (“holding period” Δt_{wait}) until the next setting of a heating pattern in order to render possible an advantageous thermal compensation due to heat conduction within the food to be cooked. It is likewise possible to pass through multiple step sequences S4 and S5 one after the other and only then in step S8 to wait for the “holding period” Δt_{wait}. In particular, in the case of the use of a magnetron, this can be preserved by the avoidance of many starts.

Optionally, for the case that the prevailing temperature distribution <T> has not yet reached or exceeded the predetermined limit temperature Tₗᵢₘᵢₜ, step S6 or step S8 (if provided) is followed by a query as to whether a new initial scan is to be performed. If this is not the case, (“No”) the method proceeds to step S4.

However, if this is the case (“Yes”), the method branches to step S2, and heating patterns <ΔT>_{p,q} are again recorded. The method subsequently proceeds to step S3, wherein then the previously used standardized target distribution <Z> can be further used or a new standardized target distribution <Z> can be selected.

FIG. 3 illustrates as a plotting of an average surface temperature T̅ in [° C.] against a microwave treatment duration t in [s] a temporal progression of the average surface temperature T̅ of a 500 g block of minced meat during a defrosting procedure while being influenced using constant microwave power.

Starting here as an example from an initial average temperature T̅ of −17° C., which is present for example after the tuning phase, during the subsequent microwave influencing under for example continuous rotation of the rotary antenna 7 the average temperature T̅ during a warming up phase W increases in an approximately linear manner. During transition into the saturation phase S (here at T̅=−5° C. or t=approximately 50 s) the progression or the curve bends. In the saturation phase, the microwave power that is absorbed by the food to be cooked can no longer be represented in a linear manner to an increase of the average temperature T̅.

Obviously, the present invention is not limited to the illustrated exemplary embodiment.

In general, “a”, “an”, “one” etc. can be understood to mean singular or plural, in particular in the sense of “at least one” or “one or multiple” etc. as long as this is not explicitly ruled out, for example by the expression “precisely one” etc.

A numerical disclosure can also include precisely the number that is disclosed as well as a typical tolerance range as long as this is not explicitly ruled out.

### LIST OF REFERENCE CHARACTERS

1 Household microwave appliance
2 Cooking compartment
3 Loading hatch
4 Door
5 Carrier for food to be cooked
6 Microwave generating facility
7 Rotary antenna
8 Control unit
9 Thermal imaging camera
B_{p,q} Evaluating value
B_{p,q|best} Most suitable evaluating value
G Food to be cooked
S Saturation phase
S0-S9 Method steps
<T> Temperature distribution on the surface of the food to be cooked G
<T>_{begin} Temperature distribution at the beginning of a tuning phase
<T>_{end} Temperature distribution at the end of a tuning phase
<ΔT>_{p,q} Heating pattern
<ΔT>_{p,q|best} Most suitable heating pattern
T_{es;max} Maximum rise in temperature during the tuning phase
Tₗᵢₘᵢₜ Limit temperature
t Time
Δtᵢₙᵢₜ Set duration of the initial scan
Δtᵢₙᵢₜ; max Maximum possible duration of the initial scan
Δt_{wait} Holding period
T Average temperature
W Warming up phase
<Z> Standardized target state

1-12. (canceled)

13. A method for operating a household microwave appliance, said method comprising:
loading a cooking compartment with food to be cooked;
performing an initial scan by supplying microwaves into the cooking compartment using at least two different parameter configurations set in a control apparatus, with the food treatable differently in a localized manner using the microwaves having the at least two different parameter configurations, measuring with a thermal imaging sensor temperature distributions associated with the at least two different parameter configurations on a surface of the food, and determining heating patterns from differences of the temperature distributions, and following the initial scan
(a) setting at least one target temperature distribution for the food, based on a standardized target state and a prevailing temperature distribution;
(b) determining, based on the prevailing temperature distribution, a most suitable heating pattern for achieving the at least one target temperature distribution;
(c) applying to the food microwaves having a sequence of the at least two different parameter configurations associated with the most suitable heating pattern; and
(d) determining as a new prevailing temperature distribution the previously prevailing temperature distribution in addition to the most suitable heating pattern.

14. The method of claim 13, further comprising repeating steps (a) to (d) until the prevailing temperature distribution meets a predetermined cancellation criterion.

15. The method of claim 14, wherein the predetermined cancellation criterion comprises that the prevailing temperature distribution reaches or exceeds a predetermined limit temperature calculated from a quantity of energy that is required to perform a phase transformation in the food.

16. The method of claim 15, wherein the phase transformation is performed of water.

17. The method of claim 14, further comprising measuring, in addition to steps (a) to (d), with the thermal imaging sensor the temperature distribution of the food, wherein the cancellation criterion comprises that the measured temperature distribution reaches or exceeds a predetermined limit temperature.

18. The method of claim 13, further comprising prior to performing the initial scan, performing a tuning phase of the microwave generator by
measuring a heating pattern as a difference between a temperature distribution at a beginning of the tuning phase and a temperature distribution at an end of the tuning phase;
determining from the heating pattern a segment having a highest local temperature increase;
determining from the segment a maximum duration of an initial phase until water in the food reaches a phase transition; and thereafter
setting a duration of the initial phase such as not to exceed the maximum duration.

19. The method of claim 13, wherein in step (a), the at least one target temperature distribution <T_{target}> is calculated in accordance with
<T_{target}>=T̅·<Z>,
wherein T̅ is an average temperature of the prevailing temperature distribution averaged over associated segments and <Z> is the standardized target state, and wherein in step (b), the most suitable heating pattern is determined by calculating for each selected heating pattern an evaluating value B_{p,q} in accordance with
B_{p,q}=Σ(|<T_{target}>−<T>|^{d}−|<T_{target}>−(<T>+<ΔT>_{p,q})|^{d})
wherein <T> is the prevailing temperature distribution, <ΔT>_{p,q} are the heating patterns determined from the differences of the temperature distributions, and by selecting as the most suitable heating pattern the heating pattern with the highest evaluating value B_{p,q}.

20. The method of claim 13, comprising in step (a), calculating a first target temperature distribution <T_{target}> in accordance with
<T_{target}>T̅=·<Z>,
wherein T̅ is an average temperature from the prevailing temperature distribution averaged over the associated segments and <Z> is the standardized target state, and calculating for all selected heating patterns a respective second target temperature distribution <T_{target}*>_{p,q} in accordance with
<T_{target}*>_{p,q}=T̅_{p,q}·<Z>,
wherein T̅_{p,q} is the average temperature from the prevailing temperature distribution plus the selected heating pattern averaged over the associated segments, and
in step (b), determining the most suitable heating pattern, calculating for each selected heating pattern an evaluating value B_{p,q} in accordance with and selecting as the most suitable heating pattern the heating pattern having the highest evaluating value B_{p,q}.

21. The method of claim 13, wherein the at least one setting parameter comprises at least one setting parameter selected from the group consisting of angle of rotation of a rotary antenna, angle of rotation of a rotary plate, position of a mode stirrer, microwave frequency of a semiconductor-based microwave generator, and phase difference between microwaves that are supplied into the cooking compartment from different feed-in locations or ports.

22. The method of claim 13, wherein the food that is introduced into the cooking compartment is frozen food.

23. The method of claim 13, wherein the food that is introduced into the cooking compartment is food that is not frozen.

24. The method of claim 13, further comprising:
performing a further initial scan after multiple repetitions of steps (a) to (d), and
subsequently repeating steps (a) to (d) based on the further performed initial scan.

25. A household microwave appliance, comprising:
a cooking compartment configured to be loaded with food;
a microwave generator generating microwaves to which the food and located in the cooking compartment is exposed;
a thermal imaging sensor oriented into the cooking compartment and configured to determine temperature distributions on a surface of the food to be cooked; and
a control apparatus configured to set multiple parameter configurations of setting parameters of the household microwave appliance, with at least two parameter configurations treating the food to be cooked differently with the microwaves in a localized manner,
wherein the household microwave appliance is configured to implement a method as set forth in claim 16.
